(19) United States
(12) Patent Application Publication
(10) Pub. No.: US 2008/0304893 A1
(43) Pub. Date: Dec. 11, 2008

(54) Magnetic Tape

(75) Inventors: Renaat Picqueur, Zele (BE); Kris Vandermeulen, Bornem (BE)

Correspondence Address: MARSHALL, GERSTEIN & BORUN LLP, 233 S. WACKER DRIVE, SUITE 6300, SEARS TOWER, CHICAGO, IL, 60606, US

(73) Assignee: DYMO, Sint-Niklass (BE)

(21) Appl. No.: 12/158,310

(22) PCT Filed: Dec. 19, 2006
(86) PCT No.: PCT/IB06/04123

§ 371 Date: Jul. 9, 2008

(30) Foreign Application Priority Data
Dec. 19, 2005 (GB) 0525766.2

(51) Int. Cl. B41J 11/00; B32B 9/00

(52) U.S. Cl. 400/613; 428/195.1

(57) ABSTRACT

A supply of image receiving medium for a label printer, said image receiving medium arranged to receive an image and comprising a magnetic layer, wherein said magnetic layer is anisotropic.

The present invention relates to a supply of image receiving medium for a label printer and to a label printer in combination with such a supply of image receiving medium. The supply of image receiving medium is preferably, but not exclusively, housed in a cassette.

Label printers are known. Label printers are arranged to operate with a supply of image receiving medium which is arranged to receive an image. Optionally, ink ribbon may be provided for transferring an image on to the image receiving medium. Alternatively, an image can be printed directly on the image receiving medium using direct thermal image receiving medium in combination with a thermal print head. In known label printers, the supply of image receiving medium may be housed in an image receiving medium holding case or cassette, or the supply of image receiving medium may be mounted on a spool in the label printer. A supply of image transfer ribbon (ink ribbon), if provided, can be provided in the same cassette as the image receiving medium or in a different cassette. The image receiving medium and ink ribbon, where provided, are passed in overlap through a printing zone of the label printer. A label printer operating with a cassette of this type is described for example in EP-A-0267890 (Varitronic, Inc).

Other printing devices are known in which letters are transferred to an image receiving medium by a dry lettering or dry film impression process.

In the known label printers, the construction of the image receiving medium generally takes the form of an upper layer for receiving an image which is secured to a releasable backing layer by a layer of adhesive. Once an image or message has been printed on the image receiving medium, it is desired to cut off that portion of the image receiving medium to enable it to be used as a label. Thus it is necessary to remove the releasable backing layer from the upper layer to enable the upper layer to be secured to a surface by means of the adhesive layer. In EP-A-267890 scissors are used to cut off the image receiving medium. Alternatively, the image receiving medium is in the form of die cut labels which are secured to a continuous backing layer by a layer of adhesive.

The known labels are sufficient for normal applications like labelling tools, labelling files, address labels, etc. For more specific applications or environments, the known labels have disadvantages or can not be used at all. It is, for example, difficult to read labels in dark environments.

In another application, it is desirable to print magnetic affixable labels to affix labels to a whiteboard of steel or other metal substrate. Magnetic affixable printing tapes which can be printed in a tape printer are described in EP-988984 and EP-988987. EP-0988984 discloses a printing layer secured to a magnetic layer of magnetic powder magnetised lengthwise. EP-0988987 discloses a tape comprising a printing layer and a magnetic layer of magnetic powder magnetised widthwise.

A problem of these known magnetic affixable printing tapes is that the magnetic force between the resulting labels and ferromagnetic objects is too low. The magnetic affixable printing tape is thin to get an acceptable amount of tape in a cassette or on a spool of known label printers and to ensure that the tape is easily coiled. Additionally, these magnetic tapes are designed to be used with label printers which can print on other image receiving media such as paper or plastics. The magnetic printing tape needs to be relatively thin to allow a common feeding/printing mechanism to be used with all the different types of image receiving media. In any event the thicker the tape, the more difficulties there are associated with feeding. The known tape thus has a thin magnetic layer with a low magnetic force.

Another problem which arises with known magnetic affixable labels, produced in label printers as described above, is that the magnetic label is not flat after printing and that the label releases itself from the ferromagnetic objects after the label is affixed thereto. The magnetic labels curl when they get out of the label printer. To make the labels generally flat, the user has to bend the labels in the opposite direction of the curl.

The problem of too low fixing forces can be solved by a thicker magnetic layer but the curling problem can be solved by a thinner magnetic layer. Thus the solution for the one problem makes the other problem worse.

### STATEMENT OF INVENTION

It is therefore an aim of the embodiments of the present invention to address one or more of the above described problems.

According to one aspect the present invention, there is provided a supply of image receiving medium for a label printer, said image receiving medium arranged to receive an image and comprising a magnetic layer, wherein said magnetic layer is an isotropic.

According to another aspect of the present invention, there is provided a supply of image receiving medium for a label printer, said image receiving medium arranged to receive an image and comprising phosphorescent pigments.

According to another aspect of the present invention, there is provided a cassette for a label printer, said cassette comprising at least one portion arranged to define an area for a supply of image receiving medium as previously described, wherein said supply of image receiving medium is positioned in said cassette by said supply spool.

According to another aspect of the present invention, there is provided a cassette comprising a housing having an exit; a supply of image receiving tape in said housing, said image receiving tape comprising a coiled part and an unwound part, said unwound part being arranged between said coiled part and said exit; and biasing means arranged to act on said unwound part so that the image receiving tape is prevented from moving away from the exit.

For a better understanding of the present invention and as to how the same may be carried into effect reference will now be made by way of example to the accompanying drawings in which:

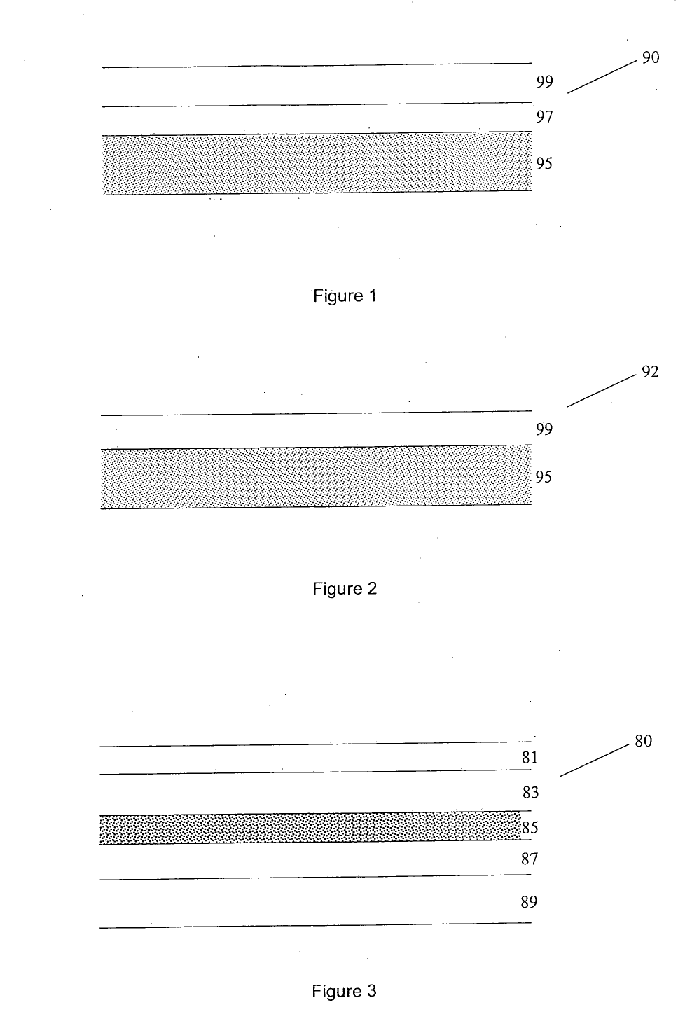

FIG. 1 is a first material embodying the present invention;

FIG. 2 is a second material embodying the present invention;

FIG. 3 is a third material embodying the present invention;

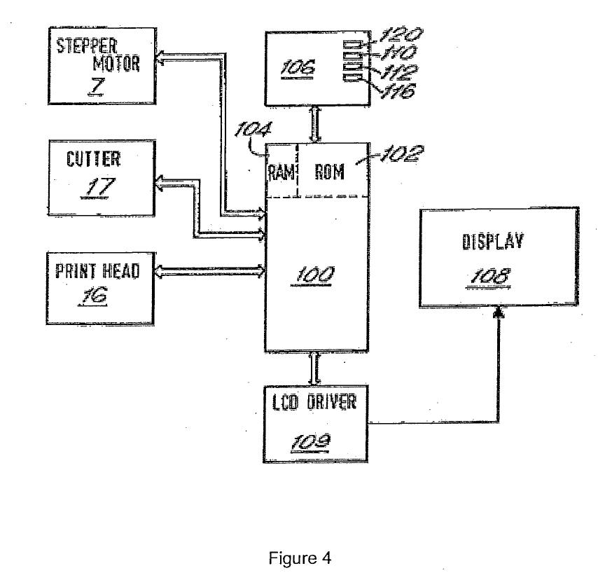

FIG. 4 is diagrammatic sketch showing the control circuitry for a label printer in which embodiments of the present invention can be incorporated;

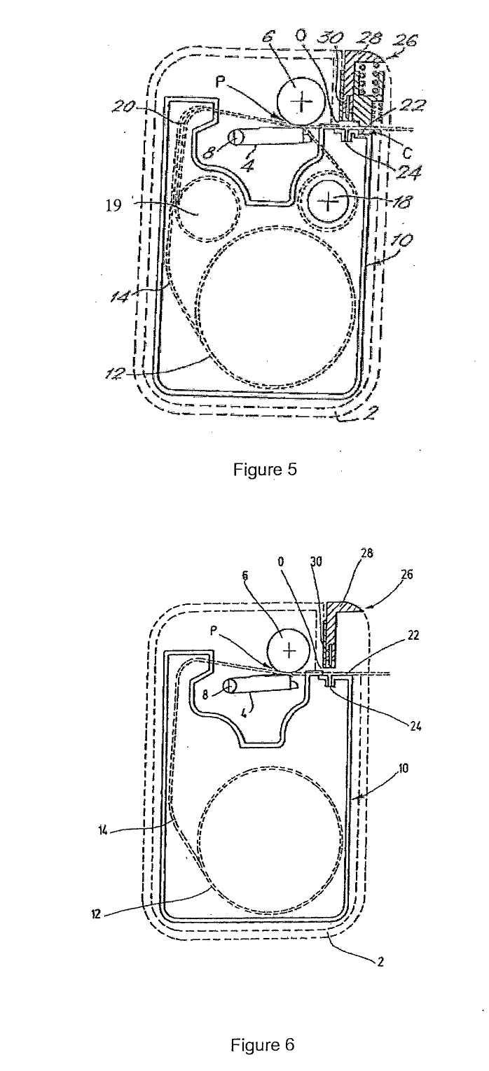

FIG. 5 is a plan view showing a cassette inserted in a one cassette system label printer;

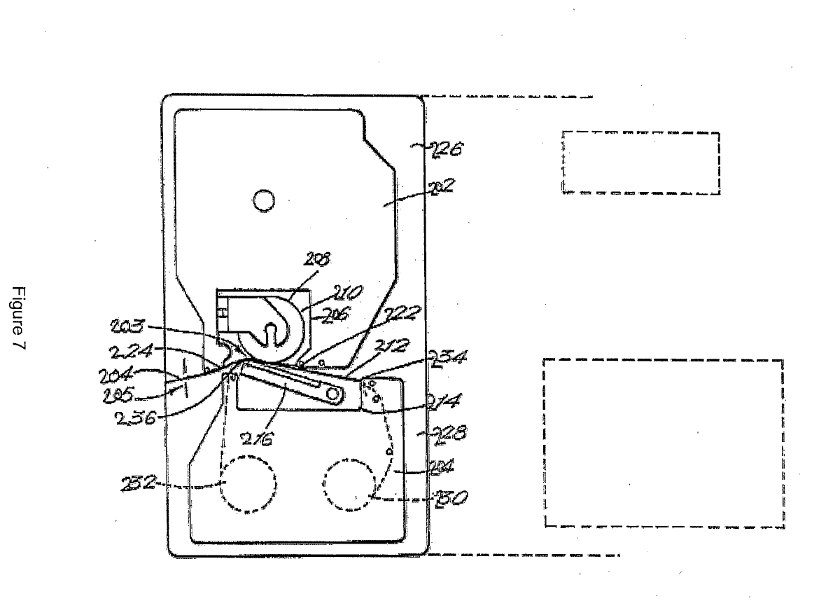

FIG. 6 is a similar plan view to that of FIG. 5 showing a cassette without ink ribbon inserted in the label printer;

FIG. 7 shows a two cassettes inserted in a two cassette system label printer;

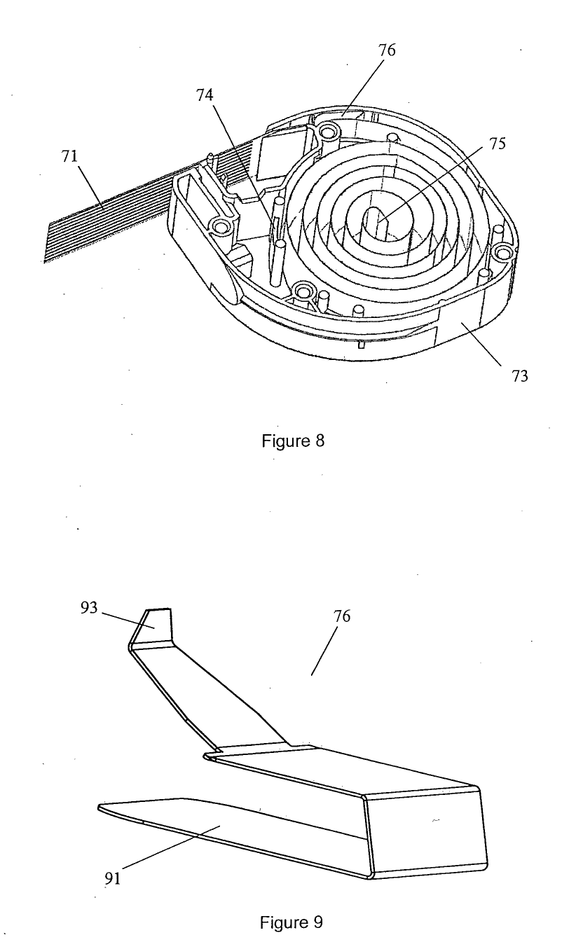

FIG. 8 shows a further cassette embodying the invention, with the top removed;

FIG. 9 shows a perspective view of a spring of the cassette of FIG. 8;

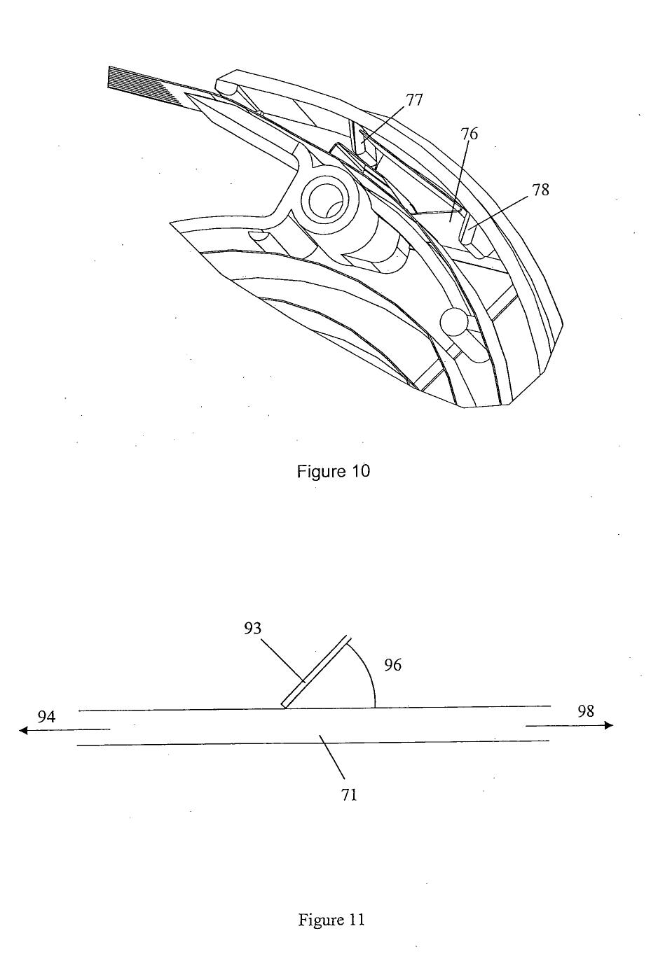

FIG. 10 shows an enlarged view of the spring positioned in the cassette of FIG. 8;

FIG. 11 shows schematically the contact between the top part of the spring of FIG. 9 and the image receiving medium.

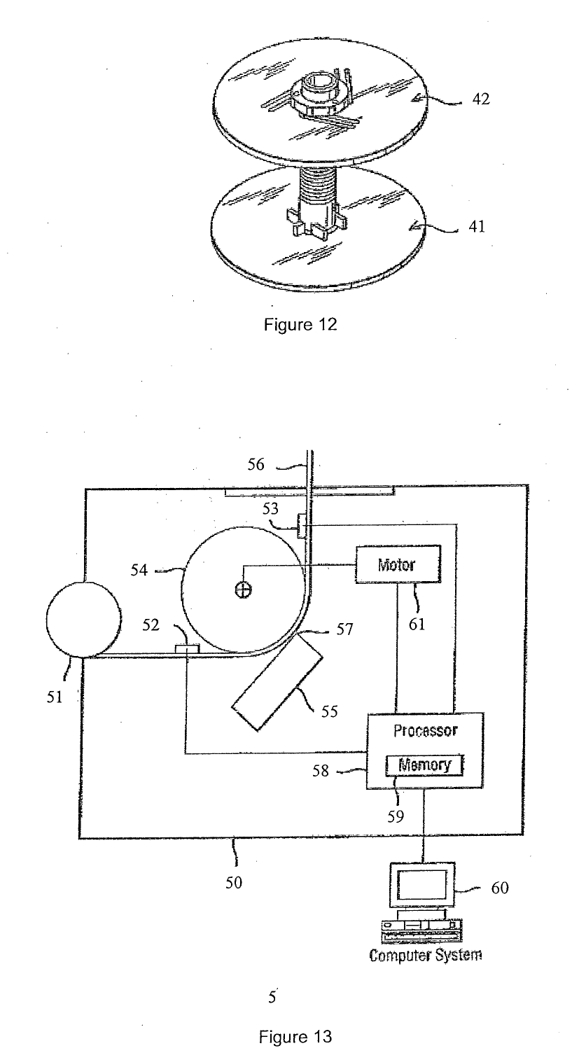

FIG. 12 shows a spool structure for supporting a supply of image receiving tape; and

FIG. 13 is a block diagram of a label printing system in which embodiment of the invention are incorporated.

FIG. 1 shows a first embodiment of an image receiving material according to the present invention. The image receiving material 90 comprises a printable layer 99 and a layer of magnetic material 95. The printable layer 99 is adhered to the layer of magnetic material 95 by an adhesive layer 97.

Alternatively, the printable layer 99 is coated on the magnetic layer 95 resulting in an image receiving material 92 illustrated in FIG. 2.

The magnetic material of the magnetic layer is preferably anisotropic magnetic material. Using anisotropic magnetic material for a magnetic label has the advantage that the magnetic force is higher compared to the magnetic force of an identical label with isotropic magnetic material. Anisotropic indicates that a preferred magnetic axis has been fixed during manufacture of the magnetic material in order to produce higher magnetic properties in that preferred direction. Anisotropic magnets have magnetic properties about 30% higher than isotropic magnets. The advantage of using anisotropic magnetic material for a supply of image receiving medium for label printers is that the magnetic force of the magnetic material to a ferromagnetic object is higher than the magnetic materials used in the known supplies of image receiving medium. The higher magnetic force is in the first place advantageous to avoid the problem that a magnetic label curls away from an object when it is applied to it. A second advantage is that the thickness of the image receiving medium can be reduced while still providing a required force and that accordingly a larger amount of image receiving medium can be placed in a cassette or on a spool.

Preferably, flexible anisotropic magnetic material is used.

The anisotropic magnetic material in the image receiving medium may be magnetised lengthwise such that a plurality of strip-like S and N Poles extend through the length of the image receiving medium, or widthwise such that a plurality of strip-like S and N poles are formed perpendicular on the lengthwise direction of the image receiving medium. Preferably, the anisotropic magnetic material in the image receiving medium will be magnetised lengthwise.

A good permanent magnet should produce a high magnetic field with a low mass, and should be stable against the influences which would demagnetize it. The desirable properties of such magnets are typically stated in terms of the remanence (also called residual induction) and coercivity (also called coercive force) of magnetic materials. When a ferromagnetic material is magnetised in one direction, it will not relax back to zero magnetization when the imposed magnetizing field is removed. The amount of magnetization it retains at zero driving field is called its remanence or residual induction (Br).

To demagetize the material, the material must be driven back to zero by a field in the opposite direction. The amount of reverse driving field required to demagnetize the material, is called its coercivity or coercive force (Hc).

A typical remanence value for isotropic flexible rubber magnets is 150 to 170 mT and for anisotropic flexible rubber magnets 235 to 245 mT. The Tesla (symbolized T) is the standard unit of magnetic flux density. It is equivalent to one weber per meter squared (1 Wb/m²). Reduced to base units in the International System of Units, 1 T represents one kilogram per second squared per ampere (kg/(s²*A)).

A typical coercivity value for isotropic flexible rubber magnets is 96 to 112 kA/m and for anisotropic flexible rubber magnets 160 to 168 kA/m. Ampere per meter is the unit of magnetic field strength in the International System of Units.

The printable layer 99 is preferable a layer of thermal sensitive material. Alternatively, the printable layer is a layer of any kind of material used in known thermal transfer printers, e.g. paper, plastic, etc.

The image receiving medium containing a magnetic layer can have different constructions. The printable layer may be a continuous layer which is adhered to a continuous magnetic layer. Alternatively the printable layer comprises several die-cut labels. Each die-cut label is adhered to or has a respective magnetic layer and the resulting magnetic layer is secured to a continuous backing layer by an adhesive layer. When the image receiving medium is printed, the printed die cut magnetic label can be removed from the backing layer whereby the adhesive layer stays on the backing layer.

FIG. 3 shows a further embodiment of an image receiving material according to the present invention. The image receiving material 80 comprises a layer of ink with phosphorescent pigments 85, which will be referred to as a phosphorescent layer.

The phosphorescent pigments can have different properties. There is a first category of phosphorescent pigments which absorb visible and UV light, and re-emit a phosphorescent light. This means that the label is visible after the visible/UV light source has been removed. In this category a distinction is made between phosphorescent pigments which emit light for approximately 5 to 10 minutes after the exposure to the visible and/or UV light has been taken away and phosphorescent pigments which emit light for approximately 5 to 10 hours after the exposure to visible and/or UV light has been taken away.

A second category of inks with phosphorescent pigments use radioactive components which act on the phosphor pigments to become a permanent light emitting ink. These pigments do not have to be exposed to visible and/or UV light in order to be photoluminescent.

The color of the re-emitted phosphorescent light can be yellow-greenish, pink, orange, red or blue depending on the used phosphorescent layer. In preferred embodiment a yellow-greenish phosphorescent light is obtained.

All of these inks can be used to create image receiving material 80 for specific applications. The phosphorescent layer is adhered to a transparent substrate layer 83, wherein the substrate layer may or may not include a layer of thermally sensitive material. Preferably, as illustrated in FIG. 3, the ink with phosphorescent pigments 85 is coated on a surface of a transparent substrate layer 83 and a thermally sensitive layer 81 is coated on the other surface of the substrate layer 83. An adhesive layer 87 secures the coated substrate layer to a releasable backing layer 89. When an image is printed on the image receiving material, the printed image can be seen and/or read in the dark as the label emits light over the whole area of the label, except on the areas where the image is printed (knock-out text).

In another embodiment of the present invention a layer of ink with phosphorescent pigments is adhered to a transparent substrate layer. The transparent substrate layer may have a thermal sensitive layer to form an image via direct thermal printing or the transparent substrate layer may have a surface sufficient to print an image on it via thermal transfer printing. A layer of magnetic material is further adhered to the phosphorescent layer to create image receiving material which can be used to create phosphorescent magnetic labels.

In another embodiment of the invention, the phosphorescent material is incorporated in a thermally sensitive layer or any other suitable layer.

The image receiving medium may be coiled on a supply spool or the image receiving medium may be coiled without a spool and positioned free in the housing of a cassette.

The basic circuitry for controlling the label printer is shown in FIG. 4. There is a microprocessor chip 100 having read only memory ROM 102, a microprocessor and random access memory capacity indicated diagrammatically by RAM 104. The microprocessor is connected to receive data input to it from a data input device such as a keyboard 106. The microprocessor chip 100 outputs data to drive a display 108 via a display driver chip 109 and also to drive the print head 16 and the motor 7 for controlling the platen. The motor 7 may be a stepper motor or a DC motor controlled by an encoder arrangement or the like.

The microprocessor chip 100 also controls a cutting mechanism including a cutter 17 to cut off a length of printed image receiving medium. It should be appreciated that in some embodiments of the present invention, a manual cutter mechanism may be alternatively provided.

The operation of the label printer will now be described. Data to be printed is input into the label printing device using the data input device, for example using keys on the keyboard 106. The data input keys are designated generally by block 106 but will in practice comprise a plurality of lettered and numbered keys (for example keys 110, 112, 116 and 120). As the data is entered via the keyboard 106 it is supplied to the microprocessor which causes the display 108 to display the data as it is entered. To do this, for each character which is entered, the microprocessor calls up a stored version of the character from the ROM 102. As the character is stored in compressed form, this font data is stored temporarily in the RAM 104 and is manipulated by the microprocessor 100 to generate pixel data to form the character. This pixel data is transmitted in one form to the display 108 and in another form to the print head for printing. Character data is not passed to the print head for printing until the print operation is executed.

Reference is now made to FIG. 5 which illustrates in plan view a cassette bay of the label printer. The cassette bay is shown by the dotted line 2. The cassette receiving bay includes a thermal print head 4 and a platen 6 which co-operate to define a print location P in a manner which is known in the art. The print head 4 is pivotable about a pivot point 8 so that it can be brought into contact with a platen 6 for printing and moved away from the platen to enable a cassette to be removed and replaced.

The cassette inserted into the cassette bay is denoted generally by the reference number 10. The cassette holds a supply spool 12 of image receiving medium 14. The image receiving medium 14 is guided by a guide mechanism through the cassette, out of the cassette through an outlet 0, passed the print location P to a cutting location C. The cassette also has an ink ribbon supply spool 19 and an ink ribbon take up spool 18. The ink ribbon 20 is guided from the ink ribbon supply spool 19 through the print location P and is taken up on the ink ribbon take up spool 18. The image receiving medium passes in overlap with the ink ribbon through the print location with the image receiving medium in contact with the ink ribbon.

The platen 6 is driven so that it rotates to drive the image receiving medium 14 past the print location for printing. In this way, image receiving medium is printed and fed out from the print location P to the cutting location C. The cutting location C may be provided at any suitable location, for example downstream of the cassette. However, in preferred embodiments of the present invention, the cutting location may be provided at a location on a portion of the wall of cassette 10 which is close to the print location P. As the image receiving medium is fed out of the cassette by driving the platen, there is no need for a further feed mechanism for the image receiving medium and this enables the cutting location C to be closer to the print location P.

The portion of the wall of the cassette where the cutting location C is defined is denoted by reference numeral 22. A slot 24 is defined in the wall portion and the image receiving medium 14 is feed past the print location P to the cutting location C where it is supported by facing wall portion on either side of the slot. The label printer includes a cutting mechanism generally denoted by reference numeral 26. This cutting mechanism includes a cutter support member 28 which carries a blade 30. The blade 30 cuts the image receiving medium and then enters the slot 24 with the leading part of its edge first, rather than bearing against an anvil.

The cassette shown in FIG. 5 can be modified so as to only include the image receiving medium. The modified cassette is shown in FIG. 6. FIG. 6 illustrates a horizontal section through a cassette receiving member of a printing device. The cassette receiving member is shown by the dotted line 2. The cassette receiving member 2 includes a thermal print head 4 and a platen 6 which cooperate to define a print location P in the same way as described in FIG. 5. The thermal print head is in this embodiment in contact with the image receiving medium. The image receiving medium has at least one thermally sensitive layer so that an image is formed in the image receiving medium when the print head is heated.

Reference will now be made to FIG. 7 which shows in plan view two cassettes arranged in a label printer. The upper cassette 202 is located in the first cassette receiving portion 226 and contains a supply of image receiving medium 204 which passes through a print zone 203 in the label printer to an outlet 205 for the printer.

The cassette 202 has a recess 206 for accommodating a platen 208 of the printer and guide portions 222, 224 for guiding the image receiving medium 204 through the print zone. The platen 208 is mounted for rotation within a cage moulding 210. As an alternative, the platen 208 could be mounted for rotation on a pin. The lower cassette 244 is located in the second cassette receiving portion 228 and contains a thermal transfer ribbon which extends from a supply spool 230 to a take up spool 232 within the cassette 244. The thermal transfer ribbon 212 extends to the print zone 203 in overlap with the image receiving medium 204. The cassette 244 has a recess 214 for receiving a print head 216 of the printer and guide portions 234, 236 for guiding the ink ribbon 212 through the print zone 203.

The print head 216 is moveable between an operative position, shown in FIG. 7, in which it is in contact with the platen and holds the thermal transfer ribbon 212 and the image receiving medium 204 in overlap between the print head and the platen and an inoperative position in which it is moved away from the platen to release the thermal transfer ribbon and image receiving medium. In the operative position, the platen is rotated to cause the image receiving medium to be driven past the print head and the print head is controlled to print an image on to the image receiving medium by thermal transfer of ink from the ribbon 212.

The print head is a conventional thermal print head having an array of pixels each of which can be thermally activated in accordance with the desired image to be printed.

The label printer may have a lid which is not shown but which is hinged along the rear of the cassette receiving portion and which covers both cassettes when in place.

The basic control circuitry described in relation to FIG. 4 can also be used in the embodiment shown in FIG. 7.

FIG. 8 is an example of a cassette wherein the image receiving medium 71 is coiled within the cassette case 73, with the end of the coil 75 left free, and nothing in the centre of the coil, that is no supporting spool or the like. The image receiving medium is supported by wall portions 74 of the cassette. A coil of image receiving medium normally expands when it is positioned in the cassette until the outer surface of the coil of image receiving medium is in contact with the wall portions of the cassette. The pull out force to move the image receiving medium out of the cassette overcomes the friction between the outer surface of the coil of image receiving medium and the wall portions of the cassette. The friction between the outer surface of the coiled image receiving medium and the wall portions of the cassette also avoid that the image receiving medium can move back into the cassette due to vibrations during transport.

When the image receiving medium has a layer of magnetic material, the magnetic forces keep the coil of image receiving medium together and the coil of image receiving is no longer expanding to make contact with the wall portions. The inner diameter of a coil of image receiving medium with a magnetic layer is substantially constant during unwinding of the coil. The pull out force is determined by the force necessary to overcome the magnetic forces which keep the coil of image receiving medium together. Tests have shown that the image receiving medium moves into the cassette during vibration of the cassette. When the image receiving medium is moved too much into the cassette, there is no contact between the feed roller of a tape printer and the image receiving medium when the cassette is positioned in the label printer and the label printer can not print on the image receiving medium. The reason for this problem is the magnetic forces which act on the unwound part of the image receiving medium tend to roll up the unwound part of the image receiving medium.

A solution is to fix the unwounded part of the image receiving medium to the cassette during transport. However, this does not address the problem for a user who wants to transport a label printer with a cassette positioned in it or for a user who wants to transport a cassette which has been used before.

To overcome above mentioned problem a spring 76 is positioned in the cassette. The spring 76 increases the pull out force required and avoids that the image receiving medium moves into the cassette due to vibrations during transport.

FIGS. 9 and 10 show respectively the spring 76 and the positioning of the spring in the cassette in more detail. The spring has a first substantially flat part, referred to as the mounting part 91. A second substantially flat part is bended from the mounting part with angle α preferably greater than 90 degrees. A third substantially flat part is bended from the second part with an angle β preferably smaller than 90 degrees, such that the mounting part and the third part or substantially parallel. A fourth substantially flat part is bended from the third part with an angle γ preferably smaller than 90 degrees in a direction away from the mounting part. A fifth substantially flat part, referred to as the end part 93, is bended from the fourth part with an angle δ preferably smaller than 90 degrees in the same direction as angle γ. The sum of angles γ and δ is preferably smaller than 90 degrees. Part 91 of the spring is positioned in the cassette between ribs 77 and 78 on a side wall of the cassette. The end part 93 of the spring acts on the image receiving medium. The shape of the spring is designed such that the force necessary to move the image receiving medium out of the cassette is increased less by the spring than the force necessary to move the image receiving medium back into the cassette. The top of the spring contacts the image receiving medium. The top part of the spring contacts the image receiving medium preferably under an angle 96 between 0 and 90 degrees. This is illustrated in FIG. 11. The sharp edge contact under an angle 96 results in a higher resistance to move the image receiving tape back into the cassette (in the direction of arrow 98) than out the cassette (in the direction of arrow 94).

In another embodiment of the present invention the supply of image receiving medium is not housed in a cassette case, but supported on a spool of a label printer.

An example of such a spool is illustrated in FIG. 12. The supply of image receiving medium is supported by a first part 41 with the second part 42 slid over the shaft of the first part. The position of the disc of the second part 42 on the shaft of the first part 41 will depend on the width of the label material. In this way, a common spool can be used with a range of different sizes of label supply and/or tolerances in the size of the label material can be accommodated.

FIG. 13 is a block diagram of a label printing system for printing information on to a supply of image receiving medium in accordance with an embodiment of the present invention. The label printing system 5 includes a label printer 50 and a computer system 60. The label printer 50 accepts a spool with supply of image receiving medium 51 and prints information onto the supply of image receiving medium. The supply of image receiving medium 51 on the spool may comprise discrete or die cut labels, carried on a backing layer of a continuous length of material, or continuous tape onto which an image can be printed.

The label printer 50 includes a top of form (TOF) sensor 52, a label size indicator (LSI) sensor 53, a platen 54, a motor 61, a print head 55, an exit point 56 and a processor 58. The processor 58 includes a memory module 59 for storing information including data that printer 50 collects. The TOF sensor 52 is arranged to detect TOF marks (not shown) on the label material. The TOF sensor 52 also detects the presence or absence of the label material. The LSI sensor 53 is able to detect LSI marks (not shown) on the label material and the presence or absence of the label material.

The motor 61 drives the platen 54 such that the platen turns in a clockwise or counter-clockwise direction. Rotation of the platen 54 causes the label material to advance in a forward direction if the platen 54 rotates in a counter-clockwise direction or to advance in a reverse direction if the platen rotates in a clockwise direction.

Print head 55 prints information onto the label material. The print head is arranged such that the information is printed at a pinch point 57 of the platen and the print head.

In one embodiment, the memory module 59 includes volatile and non-volatile memory. In another embodiment, the volatile memory is random access memory. In yet another embodiment, the non-volatile memory may include flash memory.

The computer system 60 sends print requests to the label printer 50. The label printer 50 sends information to the computer system 60 describing the types of labels contained on the label supply 51, whether or not the label printer 50 is ready to print and the like. This information allows the computer system 60 to format print requests to the label printer 50.

The embodiment shown in FIG. 5 shows a label printer which is used in conjunction with a computer system such as a PC. It should be appreciated that in some embodiments of the present invention, the label printer may be a stand alone printer or have two modes of operation in which it is able to operate as a stand alone printer or be controlled by a computer system.

1. A supply of image receiving medium for a label printer, said image receiving medium arranged to receive an image and comprising a magnetic layer, wherein said magnetic layer is anisotropic.

2. A supply of image receiving medium according to claim 1, wherein said magnetic layer is flexible.

3. A supply of image receiving medium according to claim 2, wherein said flexible magnetic layer comprises ferrite material and a binder.

4. A supply of image receiving medium according to claim 3, wherein said binder comprises at least one of rubber and plastics.

5. A supply of image receiving medium according to claim 3, wherein said ferrite material comprises at least one of Strontium and Barium.

6. A supply of image receiving medium according to claim 1, wherein a magnetic axis of said anisotropic material is in a lengthwise direction of said supply of image receiving medium.

7. A supply of image receiving medium according to claim 1, wherein said magnetic layer is arranged such that a plurality of strip-like S and N Poles extend through the length of the supply of image receiving medium.

8. A supply of image receiving medium according to claim 1, wherein a magnetic axis of said anisotropic material is in a widthwise direction of said supply of image receiving medium.

9. A supply of image receiving medium according to claim 1, wherein said magnetic layer is arranged such that a plurality of strip-like S and N Poles extend through the width of said supply of image receiving medium.

10. A supply of image receiving medium according to claim 1, wherein said image receiving medium comprises thermally activatable colorants for providing an image.

11. A supply of image receiving medium according to claim 10, wherein said image receiving medium further comprises phosphorescent pigments.

12. A supply of image receiving medium according to claim 1, wherein said supply of image receiving medium comprises an adhesive layer between a printable layer and said magnetic layer.

13. A supply of image receiving medium according to claim 12, wherein said supply of image receiving medium is continuous tape.

14. A supply of image receiving medium according to claim 1, wherein the supply of image receiving medium comprises a plurality of discrete labels arranged on a backing layer.

15. A supply of image receiving medium according to claim 14, wherein an adhesive layer is provided between said discrete labels and said backing layer and wherein said adhesive layer is arranged to stay on said backing layer when said discrete labels are released from said backing layer.

16. A supply of image receiving medium for a label printer, said image receiving medium arranged to receive an image and comprising phosphorescent pigments.

17. A supply of image receiving medium according to claim 12, wherein said printable layer comprises thermally activated colorants for producing an image on said supply of image receiving medium.

18. A supply of image receiving medium according to claim 17, wherein said supply of image receiving medium further comprises an adhesive layer on a layer with phosphorescent pigments, and a backing layer attached to a free surface of said adhesive layer.

19. A supply of image receiving medium according to claim 1, wherein said supply of image receiving medium comprises a spool on which said image receiving medium is coiled.

20. A cassette for a label printer, said cassette comprising a supply of image receiving medium according to claim 1.

21. A cassette according to claim 20, wherein said cassette comprises a housing comprising at least one wall portion arranged to define an area for said supply of image receiving medium and wherein said supply of image receiving medium is positioned in said cassette by said at least one wall portion.

22. A cassette for a label printer, said cassette comprising at least one portion arranged to define an area for a supply of image receiving medium according to claim 19, wherein said supply of image receiving medium is positioned in said cassette by said spool.

23. A cassette according to claim 21, wherein said at least one wall portion has at least one opening through which said image receiving medium is guided to exit said cassette.

24. A cassette according to claim 23, wherein said at least one wall portion is a side wall of said cassette.

25. A cassette for a label printer, said cassette comprising a housing, a supply of image receiving medium according to claim 1, and biasing member which act on said supply of image receiving medium.

26. A cassette according to claim 25, wherein said biasing member is arranged such that a force to overcome the biasing member to remove said image receiving medium from the cassette is less than a force to overcome the biasing member to move the image receiving medium into the cassette.

27. A cassette according to claim 26, wherein the housing has at least one rib to position said biasing member in the housing.

28. A cassette according to claim 26, wherein said housing comprises an opening through which the image receiving medium exits the cassette, wherein said supply of image receiving medium comprises a coiled part and an unwound part between said coiled part and said opening, and wherein said biasing member acts on said unwound part.

29. A cassette according to claim 27, wherein said biasing member has a mounting part, and the housing has two ribs, said mounting part being positioned between said two ribs.

30. A label printer in combination with a supply of image receiving medium as claimed in claim 1.

31. A label printer in combination with a cassette as claimed in claim 21.

32. A cassette comprising:
a housing having an exit;
a supply of image receiving tape in said housing, said image receiving tape comprising a coiled part and an unwound part, said unwound part being arranged between said coiled part and said exit; and
a biasing member arranged to act on said unwound part so that the image receiving tape is prevented from moving away from the exit.
